(19) United States
(12) Patent Application Publication
(10) Pub. No.: US 2011/0153248 A1
(43) Pub. Date: Jun. 23, 2011

(54) OPHTHALMIC QUALITY METRIC SYSTEM

(76) Inventors: Yeming Gu, Suwanee, GA (US); Ying Pi, Suwanee, GA (US); Joseph Michael Lindacher, Suwanee, GA (US)

(21) Appl. No.: 12/975,606

(22) Filed: Dec. 22, 2010

Related U.S. Application Data
(60) Provisional application No. 61/289,445, filed on Dec. 23, 2009.

(51) Int. Cl. G01M 11/02

(52) U.S. Cl. 702/81

(57) ABSTRACT

A method for automatically measuring and quantitatively evaluating the optical quality of an ophthalmic lens, such as, for example, a contact lens. The method measures an ophthalmic lens with an optical phase measurement instrument to derive measured data. The method creates a set of objective optical quality metrics within a computational software. And, the method applies the measured data to at least one of the objective optical quality metrics to determine lens quality.

This application claims the benefit under 35 U.S.C. §119 (e) of U.S. provisional application Ser. No. 61/289,445 filed on Dec. 23, 2009, herein incorporated by reference in its entirety.

### TECHNICAL FIELD

The present invention relates generally to the field of optical metrology of ophthalmic lenses, and in particular to an inspection system and method to assess the optical quality of contact lenses.

### BACKGROUND

Optical defects of ophthalmic lenses, such as contact lenses, are optical aberrations not due to design, but rather due to imperfect manufacturing processes. These optical aberrations will in general degrade the visual clarity or visual quality of the subject when the lens is worn. Examples of common aberrations are spherical aberration and coma. Spherical aberration is often associated with poor night vision and coma is associated with diplopia. In addition, all ophthalmic lenses may exhibit high spatial frequency defects. It is important to detect optical defects in, or to assess optical quality of ophthalmic lenses such as a contact lens.

Modern wavefront sensing technologies have advanced greatly. Some of these technologies have achieved adequate resolution and sensitivity to go beyond the typical average sphero-cylindrical optical power measurement and are also capable of detecting subtle optical defects. Examples of wavefront-based optical metrology systems include Shack-Hartmann based systems, lateral-shearing interferometric systems, point-diffraction systems, and Talbot imaging based systems. However, these commercial devices can be optimized to measure the average power, and the built-in data analysis software can only quantify some low spatial frequency aberrations that can be represented by low order Zernike aberration terms. This information is not adequate to assess the optical quality of contact lenses with complicated design, such as the multifocal or progressive contact lenses, or simple spherical lenses with high spatial frequency manufacturing defects.

Special instruments (such as those based on the Foucault knife-edge test) have been needed to visually detect high spatial frequency or subtle optical defects in a contact lens. However, the Foucault knife-edge test is an intensity-based test, and the wavefront or phase information is not readily available in an intensity-based test. Therefore, a Foucault test can typically only be used to make a crude subjective estimate on the potential visual degradation of a contact lens. An example of such instruments is the Contact Lens Optical Quality Analyzer (CLOQA).

### SUMMARY

In example embodiments, the present invention relates to a method for carrying out power measurement and optical quality assessment in one step using a single wavefront-based optical metrology instrument for automatic inspection of the optical quality of various forms of ophthalmic lenses, and particularly contact lenses.

In one aspect, the present invention relates to a method of computing a set of optical quality metrics based on the raw wavefront or phase map data obtained from a wavefront-based measurement device. The raw phase map represents the basic behavior of the optical light immediately after shining through the contact lens under test, including the focusing and the blurring effects. The raw phase map data will not be limited to a certain order of Zernike approximation. The designed phase data is subtracted from the raw phase data, and the residual phase is used for further evaluation of the optical quality of the contact lenses.

In another aspect, the invention relates to a computation module that is integrated into a wavefront-based measurement device for automated power and optical quality inspection for ophthalmic lenses such as contact lenses. This computation module calculates a series of optical quality metrics. A threshold setting that has been determined based on thorough correlation studies of the quality metrics and contact lens on-eye clinical tests will be used for automatic quality assessment of the contact lens.

In still another aspect, the invention relates to an image simulation module that uses the raw phase data from a single wavefront-based measurement device to simulate tasks including the Foucault-knife edge test and the visual acuity chart. These image simulations will allow for a quick inspection of the lens quality.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a flowchart showing a wavefront-sensor-based power system and a contact lens automatic defect (distortion) detection (CLADD) software module.

FIG. 2 is a flowchart showing the CLADD software module of FIG. 1 to derive a raw CLADD metric.

FIG. 3 is a flowchart showing CLADD metric development using clinical data.

FIG. 4 is a flowchart showing use of the CLADD software module to derive a contact lens optical quality metric.

FIG. 5 is a flowchart showing the process for deriving PNG images from phasemaps.

FIG. 6 is an MTF plot showing the definition of the optical quality metrics, MTF50% and MTF 80%, for a contact lens with certain defects.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

A perfect optical system has a flat wavefront aberration map and therefore metrics of wavefront quality are designed to capture the idea of flatness. An aberration map is flat if its value is constant, or if its slope or curvature is zero across the entire pupil. A good discussion of the Metrics of Wavefront Quality is found in “Metrics of Optical Quality of the Eye” written by Thibos et al. which is hereby entirely incorporated herein by reference. A series of technical terms are used in relation to the example embodiment and are defined below.

“Peak-to-Valley” (PV) is the difference between the highest (max) and lowest (min) parts on the surface of the opthalmic lens. With a residual map defined by R(x,y), calculating the PV value is completed with the formula: PV=max(R(x,y))−min(R(x,y)).

“Root Mean Squared” (RMS or STD) is a statistical measure of the magnitude of a varying quantity. With a residual map defined by R(x,y), RMS is defined by:

$$R M S = \sqrt{\frac{1}{\vert R \vert} {\sum }_{x , y} {R ( x , y )}^{2}}$$

Regarding a sum of similar values (SSV), in order to create a singular value decomposition of the data, the decomposition is placed into an “m” by “n” matrix. Because the pupil of an eye is round, there is extra space around the data. The points in the extra space are set at zero. The singular value decomposition of a matrix is defined as: U*S*V=R(x,y) where S is a diagonal matrix containing the singular values:

$$diag ( S ) = ( {σ}_{1} , {σ}_{2} , … , {σ}_{k} )$$

$$S S V = {\sum }_{i = 0}^{k} {σ}_{i}$$

“Phase Equivalent Area” is the pupil fraction when a good sub-aperture satisfies the criterion: the local residual phase is less than criterion (3.5*RMS of the residual phase over the full-aperture).

“Phase Slope Equivalent Area” is the pupil fraction when a good sub-aperture satisfies the criterion: the local horizontal slope and vertical slope are both less than criterion (1 arcmin).

“Strehl Ratio” (SRX) is the ratio of the observed peak intensity at the detection plane of a telescope or other imaging system from a point source compared to the theoretical maximum peak intensity of a perfect imaging system working at the diffraction limit. Strehl ratio is usually defined at the best focus of the imaging system under study. The intensity distribution in the image plane of a point source is generally called the point spread function (PSF).

$$S R X = \frac{max ( P S F )}{max ( {PSF}_{DL} )}$$

where PSF_{DL} is the diffraction-limited PSF for the same pupil diameter.

The point spread function describes the response of an imaging system to a point source or point object. A more general term for the PSF is a system's impulse response; the PSF being the impulse response of a focused optical system. The PSF in many contexts can be thought of as the extended blob in an image that represents an unresolved object. In functional terms it is the spatial domain version of the modulation transfer function. It is a useful concept in Fourier optics, astronomical imaging, electron microscopy and other imaging techniques such as 3D microscopy (like in Confocal laser scanning microscopy) and fluorescence microscopy. The degree of spreading (blurring) of the point object is a measure for the quality of an imaging system. In incoherent imaging systems such as fluorescent microscopes, telescopes or optical microscopes, the image formation process is linear in power and described by linear system theory. When the light is coherent, image formation is linear in complex field. This means that when two objects (A and B) are imaged simultaneously, the result is equal to the sum of the independently imaged objects. In other words: the imaging of A is unaffected by the imaging of B and vice versa, owing to the non-interacting property of photons. (The sum is of the light waves which may result in destructive and constructive interference at non-image planes.)

Light-in-the-bucket (LIB):

$$L I B = {\int }_{DLcore} {PSF}_{N} ( x , y ) d x d y$$

where PSF_{N} is the PSF normalized to unity. The domain of integration is the central core of a diffraction-limited PSF for the same pupil diameter, that is:

$${X}_{Airy} \approx \pm 2.44 λ f / D , \\ or$$

$${θ}_{Airy} \approx \pm ( \frac{{180}^{°}}{π} ) 2.44 λ / D$$

in spatial coordinates.

The “optical transfer function” (OTF) describes the spatial (angular) variation as a function of spatial (angular) frequency. When the image is projected onto a flat plane, such as photographic film or a solid state detector, spatial frequency is the preferred domain. But, when the image is referred to the lens alone, angular frequency is preferred. OTF can be broken down into the magnitude and phase components. The OTF accounts for aberration. The magnitude is known as the Modulation Transfer Function (MTF) and the phase portion is known as the Phase Transfer Function (PTF). In imaging systems, the phase component is typically not captured by the sensor. Thus, the important measure with respect to imaging systems is the MTF. OTF and MTF can be mathematically defined as:

$$O T F ( {F}_{x} , {F}_{y} ) = \frac{F T [ PSF ( x , y ) ]}{F {T [ PSF ( x , y ) ]}_{{F}_{x} = 0 , {F}_{y} = 0}}$$

$$M T F ( {F}_{x} , {F}_{y} ) = {\vert O T F ( {F}_{x} , {F}_{y} ) \vert}^{2}$$

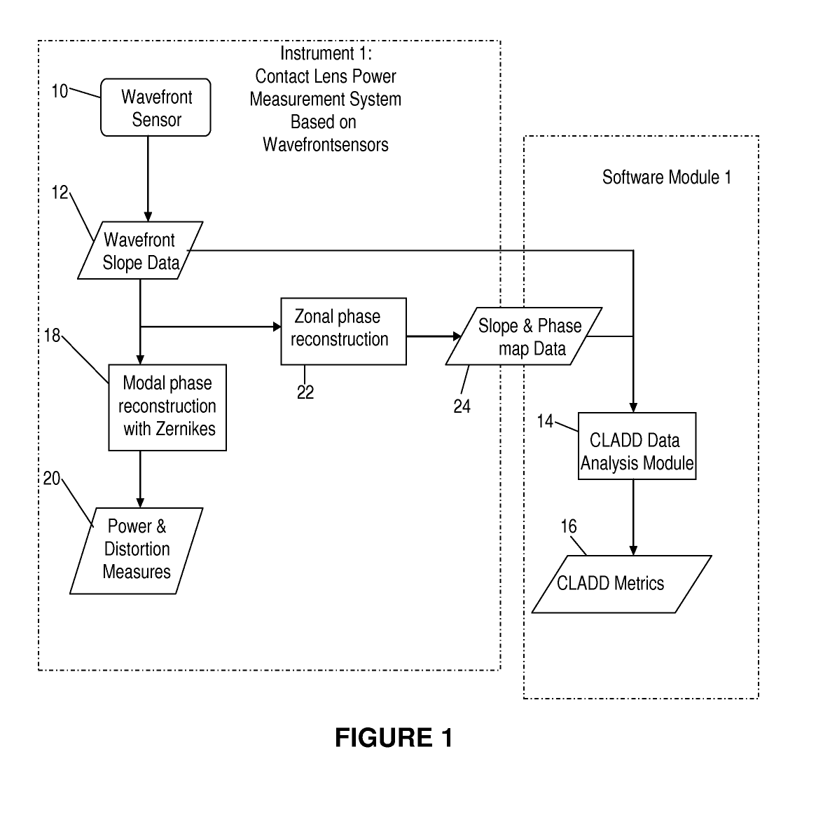

FIG. 1 shows a flowchart of a wavefront-sensor-based power measurement system used in conjunction with a contact lens automatic distortion detection (CLADD) software module. This example system can be used in performing an optical analysis technique. As shown, wavefront slope data 12 is determined by the wavefront sensor 10. The wavefront slope data 12 can be imported directly into the CLADD data analysis module 14 and then used to produce a CLADD metric 16. Alternatively, the wavefront slope data 12 can undergo modal phase reconstruction with Zernikes 18 in order to derive power and distortion measures 20. Alternatively still, the wavefront slope data 12 can undergo zonal phase reconstruction 22 to derive slope and phase map data 24 of the scanned lens. This slope and phase map data is then entered into the CLADD data analysis module 14.

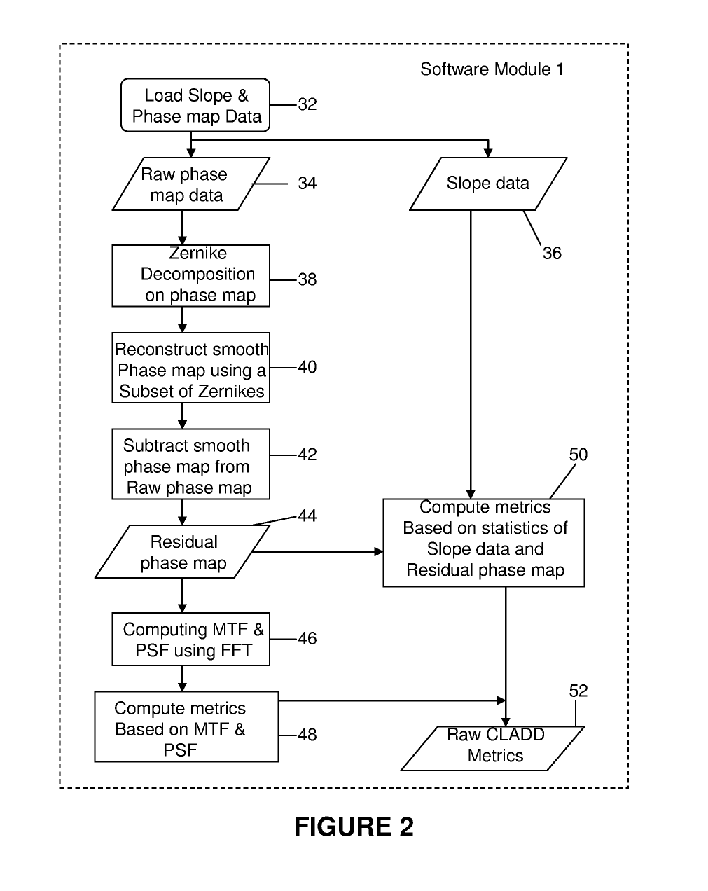

FIG. 2 shows an embodiment of the software module of the flow chart shown in FIG. 1. The slope and phase map data is loaded 32 into the software and segregated to individually represent the raw phase map data 34 and slope data 36. The raw phase map data 34 undergoes Zernike decomposition 38 in order to reconstruct 40 a smooth phase map using a subset of the Zernike polynomials. The smooth phase map is subtracted from the raw phase map 42 to produce a residual phase map 44. The residual phase map 44 is used to compute MTF and PSF using fast Fourier transform (“FFT”) 46 with the CLADD data analysis module. The software module computes metrics 48 based on the MTF and PSF computations with the CLADD data analysis module. Alternatively, and in parallel, the software module can compute metrics 50 based on statistics of the slope data 36 and residual phase map 44. Raw CLADD metrics 52 can be calculated from the MTF and PSF metrics 48 and/or the slope data and residual phase map statistic metrics 50.

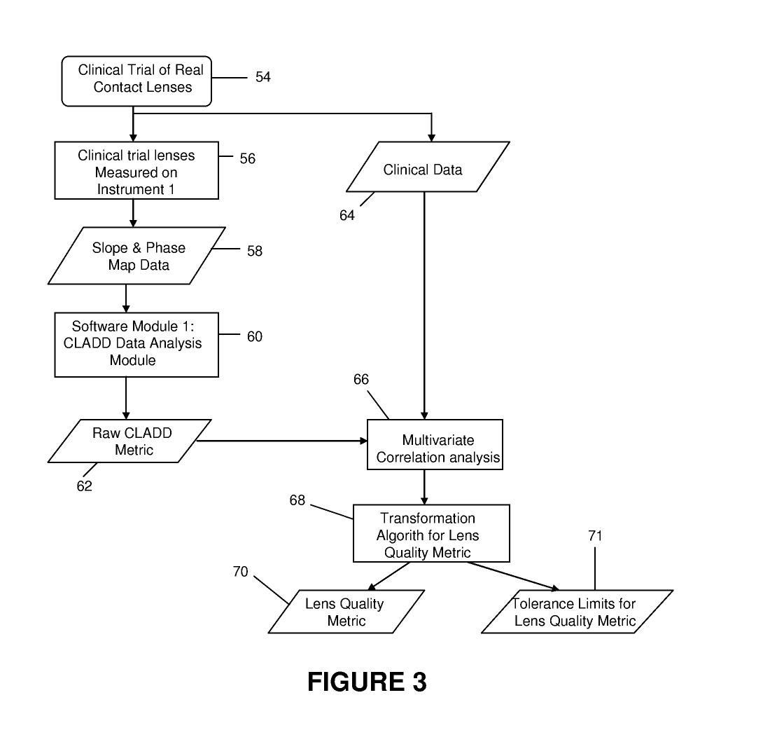

FIG. 3 shows an alternative embodiment of development of CLADD metrics using clinical trials of real contact lenses on the eyes of real patients 54. The clinical trial lenses are measured 56 on instrument 1 from FIG. 1. Instrument 1 produces slope and map phase data 58. The slope and map phase data 58 are input into the software module from FIGS. 1 and 2, to produce a CLADD data analysis module 60. The CLADD data analysis module 60 derives raw CLADD metrics 62. Alternatively, or in parallel, clinical data 64 is taken from the clinical trials 54. The clinical data 64 and/or the raw CLADD metrics 62 are incorporated into a multivariate correlation study 66. The information from the multivariate correlation study is altered using a transformation algorithm for refined metrics 68 in order to produce a lens quality metric 70 and/or tolerance limits for a lens quality metric 71.

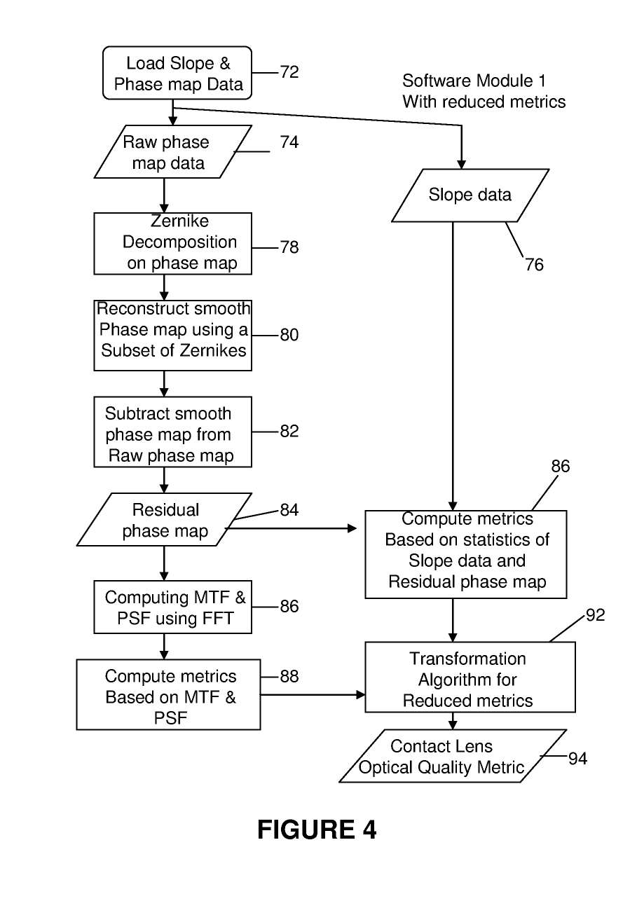

FIG. 4 shows an alternative embodiment of the FIG. 2 software module in use with refined metrics. Slope and phase map data is loaded 72 into the software. The raw phase map data 74 and slope data 76 are segregated. Zernike decomposition 78 is conducted on the phase map and a smooth phase map is reconstructed 80 using a subset of Zernikes. Smooth phase map data is subtracted from the raw phase map data 82 to produce a residual phase map 84. The residual phase map 84 is used to compute MTF and PSF using fast Fourier transform (“FFT”) 88. Metrics are computed based on MTF and PSF 90. Alternatively, or in parallel, the slope data 76 and residual phase map 84 are used to compute metrics 86. A transformation algorithm for refined metrics 92 uses the metrics 86 and 90 to derive contact lens optical quality metrics 94.

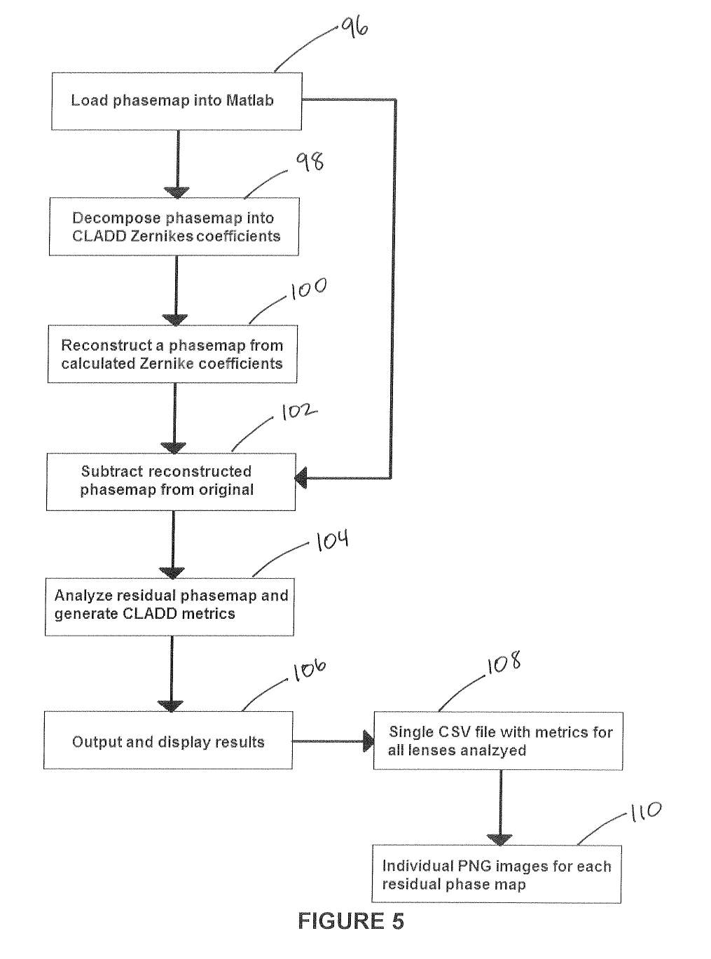

FIG. 5 shows an alternative embodiment for deriving residual phase map data. Phasemap data is loaded into Matlab™ software 96. The phasemap data is decomposed into CLADD Zernike coefficients 98. A phasemap is reconstructed from the calculated Zernike coefficients 100. The reconstructed phasemap 100 is subtracted 102 from the original phasemap 96. The residual phasemap is analyzed and CLADD metrics are generated 104. The results from the metrics are outputted and displayed 106. A single CatDV Media Catalog File (CDV) file with metrics for all lenses is analyzed 108 to produce individual portable network graphics (PNG) images for each residual phase map 110.

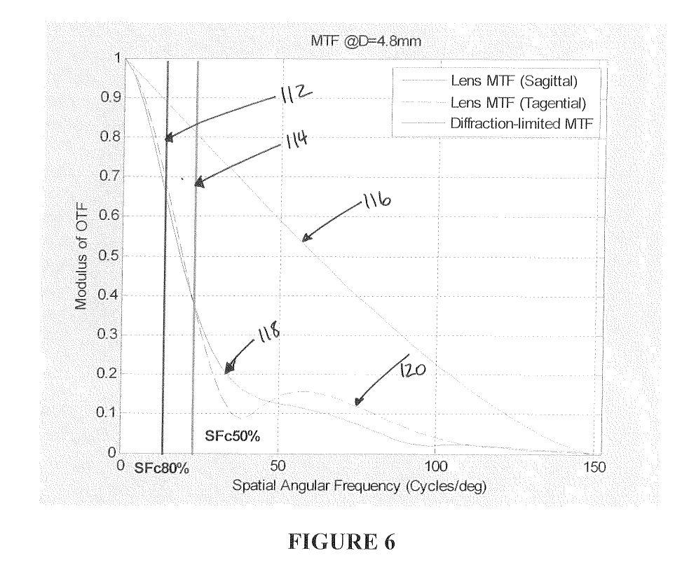

FIG. 6 shows an MTF plot showing the definition of the optical quality metrics, MTF50% and MTF 80%, for a contact lens with certain defects. As shown, Spatial Angular Frequency is represented on the x-axis in cycles/degree and modulus of OTF is represented on the y-axis. The graph is further defined by vertical barriers representing SF_{c}80% 112 and SF_{c}50% 114. A plot representing a diffraction-limited MTF 116 is shown in comparison to the Sagittal Lens MTF 118 and the Tangential Lens MTF 120.

In FIG. 6, the spatial frequency cutoff at 50% (SF_{c}50%) of radially-averaged MTF (rMTF) is intended to qualify the lens at a relatively high spatial frequency, and is determined by SF_{c}50%=lowest spatial frequency (in Snellen ratio) at which rMTF(SF_{c}50%)=0.5[rMTF_{DL}(SF_{c}50%)], where rMTF_{DL} is the diffraction-limited rMTF for the same pupil diameter, and the Snellen ratio is given by F_{θ}/30. The spatial frequency cutoff at 80% (SF_{c}80%) of a rMTF is intended to qualify the lens at a low spatial frequency, and is determined by SF_{c} 50%=lowest spatial frequency (in Snellen ratio) at which rMTF(SF_{c}80%)=0.8[rMTF_{DL}(SF_{c}80%)]. SF_{c}50% and SF_{c}80% are both high, empirically, SF_{c}50%≧0.3, and SF_{c}80%≧0.6, and the value 1 can be taken if they are greater than 1 (i.e., SF_{c}50%≦1, and SF_{c}80%≦1). AreaMTF defines the area of the region lying below the radially-averaged MTF before the cutoff frequency, SF_{c}50%. Normalization to the diffraction-limited case is taken, and:

$$AreaMTF = \frac{{\int }_{0}^{cutoff} rMTF ( f ) d f}{{\int }_{0}^{cutoff} {rMTF}_{DL} ( f ) d f}$$

In an example embodiment, the invention comprises a wavefront-based system and method that measures and quantifies optical power; including localized, high spatial frequency optical defects. The system and method of the present invention can use computational techniques including: Point Spread Function (PSF), Modulation Transfer Function (MTF), Optical Transfer Function (OTF), Root Mean Squared (RMS), Strehl Ratio, and computation image processing techniques to determine an optical quality metric or metrics. Example metrics can be calculated based upon a single pupil diameter or a plurality of pupil diameters, stimuli and weighting factors to simulate subjective vision based upon objective, comprehensive phase measurements. The system and method of the invention are applicable to a variety of types of ophthalmic lenses. Power measurement metrics and quality metrics are integrated into a single hardware device with configuration threshold settings for automated inspection.

In another example embodiment, the invention comprises a method for measuring and evaluating the optical quality of an ophthalmic lens, such as a contact lens. The measurement can be automatic and the evaluation is quantitative. A lens is placed into a cuvette. The cuvette is preferably filled with water. The cuvette and lens are secured to a location within an optical phase measurement instrument, such as a wavefront machine, and scanned. A preferred optical phase measurement instrument uses wavefront sensing technology. An example machine is the Clearwave™ device made by Wavefront Sciences, Inc. Scanning the lens measures data from the lens, including raw phase data and phase slope data. The measured raw data represents the optical defects of the lens. The data subjectively predicts how vision would be affected if the scanned lens was utilized. The optical phase measurement instrument has been tested to produce highly accurate results within a 0.02 Diopter standard deviation. The measured data is applied to a set of computed objective ophthalmic quality metrics. The metrics are a set of numbers describing aspects of distortion. When applied to the metrics, the machine determines the quality of the lens.

The ophthalmic quality metrics can be generated using statistical data entered into computational software. An example embodiment uses the computational software to generate example metrics such as an optical phase error map, a visual acuity letter simulation image, and Foucault knife edge test image via phase filtering and imaging simulation techniques.

The computational software computes the optical quality metrics based on a variety of elements input by a user. The elements can be based upon clinical test data. Example elements are Point Spread Function, Modulation of the Optical Transfer Function having a value of between 5 and 35 lps/mm, more preferably between 6 and 30 lps/mm, most preferably 15 and 30 lps/mm, Strehl Ratio, RMS Phase Error, PV Phase Error, RMS Phase Slope Error, PV Phase Slope Error, RMS Power Error, and PV Power Error. The optical quality metrics are further calculated based upon factors such as pupil diameter and weighting factors based on correlation to clinical test data. A complete discussion of most metrics can be found in “Metrics of Optical Quality of the Eye” written by Thibos et al.

The example optical analysis technique derives high spatial frequency information by subtracting low order Zernike terms of the lens from the phase measurement data entered. The system uses seven different sets of terms pre-defined for removal from the phase map. A first example Zernike subset, termed “foc”, corresponds to Z(0,0), Z(1,−1), Z(1,1), Z(2,0). A second example Zernike subset, termed “foc+sa”, corresponds to Z(0,0), Z(1,−1), Z(1,1), Z(2,0), Z(4,0). A third example Zernike subset, termed “foc+ast+sa” corresponds to Z(0,0), Z(1,−1), Z(1,1), Z(2,−2), Z(2,0), Z(2,2), Z(4,0). A fourth example Zernike subset, termed “foc+ast+coma” corresponds to Z(0,0), Z(1,−1), Z(1,1), Z(2,−2), Z(2,0), Z(2,2), Z(3,−1), Z(3,1). A fifth example Zernike subset, termed “foc+ast+coma+sa” corresponds to Z(0,0), Z(1,−1), Z(1,1), Z(2,−2), Z(2,0), Z(2,2), Z(3,−1), Z(3,1), Z(4,0). “First28Terms” describes the Zernike subset corresponding to the first 28 Zernike terms, ranging from Z(0,0) to Z(6,6). “First66Terms” describes the Zernike subset corresponding to the first 66 Zernike terms, ranging from Z(0,0) to Z(10,10). “Multifocal” describes the Zernike subset corresponding to Z(0,0), Z(1,−1), Z(1,1), Z(2,−2), Z(2,0), Z(2,2), Z(3,−1), Z(3,1), and all m=0 terms.

Example detailed and non-smoothed wavefront data can be obtained by reprocessing raw image data from a Shack-Hartmann wavefront sensor. The data is reprocessed to identify the change in local intensity distribution for Shack-Hartmann spots. Using a 2-dimensional Gaussian distribution identifies the full width at half maximum (FWHM) change and the fitted peak intensity change.

Alternatively, detailed and non-smoothed wavefront data can be obtained by reprocessing wavefront data before any smoothing or surface fitting. The wavefront data is reprocessed by starting with raw slope data from a Shack-Hartmann device or alternatively starting with a non-smoothed phase map. Wavefront data can be collected by measuring samples on a ClearWave™ CLAS-2D system and saving raw and intermediate data. The saved data can be incorporated into a Shack-Hartmann image, slope data, or phase map data. Clear images of optical defects can be derived from raw slope data measured by the ClearWave™. Most defect information is preserved in the processed phase map data. The simulated Foucault knife-edge test image using phase map data shows strong similarity to real knife-edge test image from a Contact Lens Optical Quality Analyzer (CLOQA).

An Optical Quality Metric for a contact lens can be created when Zernike fitting over a given aperture decomposes the wavefront into various Zernike terms, known as Zernike polynomials. The Zernike polynomials with different order (n) and degree (m) represent wavefront components with well-defined symmetry properties. For example, the collection of all terms with zero degree represent the axial-symmetric component of the wavefront. Similarly, the tilt and cylinder components can be associated with specific Zernike terms.

Alternatively, an Optical Quality Metric for a contact lens can be created by defining global defects (aberrations). Global defects can be defined by a cylinder component for a sphere lens and by spherical aberration not caused by design.

Alternatively still, an Optical Quality Metric for a contact lens can be created by defining localized optical defects. Localized optical defects can be designed with localized wavefront aberration from design symmetry (e.g. after tilt and cylinder components are removed, any non-axial symmetric component is considered a defect for an axially symmetric design). An aberration map can be derived either from slope data or non-smoothed phase map by subtracting the zonal averaged average or the appropriate Zernike terms (e.g., the sum of zero degree terms for axial symmetric designs). Localized optical defects can be defined by statistical description of the aberration map such as RMS error, integrated absolute deviation, and Peak to Valley deviation. Localized optical defects can be defined by topographical descriptions of the aberration map by defect area size as a fraction of aperture size (defect area is defined as area with deviation above a critical value).

Alternatively still, an Optical Quality Metric for a contact lens can be created by defining an optical quality metric using a series of defect measures and global optical quality measures such as PSF (e.g., width measurement, integrated intensity outside a predefined radius), MTF (e.g., MTF value at one or more pre-determined critical angular frequencies, and OTF.

Alternatively still, an Optical Quality Metric for a contact lens can be created by correlating quality measure with clinical data by measuring defective lenses from clinical trial and establishing correlations between various defect measures and clinical defect classification categories.

The example optical analysis technique utilizes wavefront detection machines, such as the Clearwave™ and Crystalwave™ machines manufactured by Wavefront Sciences. The example optical analysis technique realizes the Zernike fit or arbitrary term for removal or display of the resultant phase map. The example optical analysis technique realizes the image simulation of the Foucault Knife-edge test with arbitrary knife-edge placement, a measurement technique utilized in the CLOQA.

Two key algorithms utilized in the example optical analysis technique are: 1) the Zernike fitting algorithm and 2) the knife-edge simulation algorithm. Both follow straightforward mathematical manipulations. Both are verified with ZEMAX™ software calculation and simulation results. A detailed description of the Zernike fitting algorithm is discussed in “Vector Formulation for Interferogram Surface Fitting” by Fischer, et al incorporated herein by reference. The standard Zernike polynomials, zₖ(x₁,y₁), are used in the Zernike fitting algorithm. Given the wavefront aberration data, W(x₁,y₁), the Zernike polynomial coefficients, Zₖ, are calculated by:

$${Z}_{k} = Σ \frac{W \cdot {Z}_{k}}{{Z}_{k} \cdot {Z}_{k}}$$

The knife edge simulation is based on Fourier optics theory. This simulation technique is also available in ZEMAX as one of the analysis features, and a brief description can be found in “ZEMAX User's Manual” by ZEMAX Development Corporation. Detailed Fourier optics theory are described in “Introduction to Fourier Optics” by Goodman. With a plane wave illumination, the focal plane for the contact lens under test is the Fourier transform (FT) plane, and also where the knife edge is placed. The effect of the knife edge is to block a certain portion of the complex field at the focal plane. The blocked field is propagated to the position where a shadowgram is observed. The FT of the blocked field is understood as a re-imaging process. Mathematically, this process can be expressed as follows:

1) The original complex field: U(x,y)=e^{-kW(x,y)}, where

$$k = \frac{2 π}{λ} ,$$

and W(x,y) is the wavefront aberration (WFA) data. The WFA data is usually the phase map after removal of the lower order Zernike terms.
2) The complex field at focus: U_{focal}(x,y)=FT{U(x,y)}.
3) The modified field at focus: U_{focal}_{_{—}}_{blocked}(x,y)=U_{focal}(x,y)·U_{knife}(x,y), where U_{knife}(x,y) is a real function, and represents the field of the knife with amplitude given by a step function, and zero phase across the pupil. For a knife edge placed at the −x plane, for example, the field is expressed as:

$${U}_{knife} ( x , y ) = \{ \begin{matrix}1 & x > 0 \\ 0 & x \leq 0.\end{matrix}$$

4) The complex field at the observation plane is calculated with U′(x,y)=FT{U_{focal}_{_{—}}_{blocked}(x,y)}. The shadowgram can be calculated with shadowgram=U′(x,y)·conj(U′(x,y)). For simplicity, the same notation, (x,y) can be used to denote the spatial coordinates at various planes in the above equations. Mathematical differences can be assumed without confusion by one of skill in the art.

The above described method and system for optical quality analysis provides a user with power measurement and optical quality assessment for high spatial frequency defects of an ophthalmic lens in one step. The results from the metrics are outputted and displayed as a single CatDV Media Catalog File (CDV) file with metrics for all lenses to produce individual portable network graphics (PNG) images for each residual phase map.

While the invention has been described with reference to preferred and example embodiments, it will be understood by those skilled in the art that a variety of modifications, additions and deletions are within the scope of the invention, as defined by the following claims.

What is claimed is:

1. A method for automatically measuring and quantitatively evaluating the optical quality of an ophthalmic lens, comprising the steps of:
measuring an ophthalmic lens with an optical phase measurement instrument to derive measured data;
creating a set of objective optical quality metrics within a computational software program; and
applying the measured data to at least one of the objective optical quality metrics to determine lens quality.

2. The method of claim 1, wherein measuring the ophthalmic lens generates raw phase and/or phase slope data

3. The method of claim 2, wherein the data includes information representing optical defects of the lens.

4. The method of claim 3, wherein low order Zernike terms of the lens are subtracted from the phase measurement data to determine high spatial frequency information.

5. The method of claim 1, wherein the objective optical quality metrics are created using weighting factors determined from clinical test data.

6. The method of claim 1, wherein the phase measurement instrument is a wavefront sensing device.

7. The method of claim 1, wherein the computational software generates an optical phase error map, a visual acuity letter simulation image, and a Foucault knife edge test image through phase filtering and imaging simulation.

8. The method of claim 1, wherein the computational software computes at least one optical quality metrics selected from the following: a point spread function, a modulation of the optical transfer function value between about 5 and about 30 lps/mm, an RMS phase error, a PV phase error, an RMS phase slope error, a PV phase slope error, an RMS power error, a PV power error, and a Strehl ratio.

9. The method of claim 1, wherein the computational software further applies statistical data in producing a set of objective ophthalmic quality metrics and in generating the ophthalmic quality metric.

10. A method for automatically measuring and quantitatively evaluating the optical quality of an ophthalmic lens comprising:
measuring an ophthalmic lens with an optical phase measurement instrument to derive measured data; and
creating a set of objective optical quality metrics within a computational software;
wherein, measuring the ophthalmic lens generates raw phase and/or phase slope data.

11. The method of claim 10, further comprising applying the measured data to at least one of the objective optical quality metrics to determine lens quality.

12. The method of claim 10, wherein the objective optical quality metrics are calculated using pupil diameter determined from clinical test data.

13. The method of claim 10, wherein the phase measurement instrument is a wavefront sensing device.

14. The method of claim 10, wherein the measured data includes information representing optical defects of the lens.

15. The method of claim 10, wherein low order Zernike terms of the lens are subtracted from the phase measurement data to determine high spatial frequency information.

16. The method of claim 10, wherein the computational software generates an optical phase error map, a visual acuity letter simulation image, and a Foucault knife Edge test image through phase filtering and imaging simulation.

17. The method of claim 10, wherein the computational software computes at least one of optical quality metrics from the following: Point Spread Function, Modulation of the Optical Transfer Function value between about 5 and about 30 lps/mm, RMS Phase Error, PV Phase Error, RMS Phase Slope Error, PV Phase Slope Error, RMS Power Error, PV Power Error, and Strehl ratio.

18. The method of claim 10, wherein creating a set of objective ophthalmic quality metrics further comprises applying statistical data to the computational software.

19. A system for automatically measuring and quantitatively evaluating the optical quality of an ophthalmic lens comprising:
a wavefront sensing device, wherein the wavefront sensing device measures an ophthalmic lens to derive raw phase and/or phase slope data representing optical defects of the lens; and
a computational software program, wherein the computational software program creates a set of objective optical quality metrics using weighting factors determined from clinical test data within the computational software program, wherein the computational software program applies the measured data to at least one of the objective optical quality metrics to determine lens quality.

20. The system of claim 19, wherein the computational software computes at least one optical quality metrics selected from the following: a point spread function, a modulation of the optical transfer function value between about 5 and about 30 lps/mm, an RMS phase error, a PV phase error, an RMS phase slope error, a PV phase slope error, an RMS power error, a PV power error, and a Strehl ratio.
